(19) United States
(12) Patent Application Publication
(10) Pub. No.: US 2019/0318227 A1
(43) Pub. Date: Oct. 17, 2019

(54) RECOMMENDATION SYSTEM AND METHOD FOR ESTIMATING THE ELEMENTS OF A MULTI-DIMENSIONAL TENSOR ON GEOMETRIC DOMAINS FROM PARTIAL OBSERVATIONS

(71) Applicant: Fabula Al Limited, London (GB)

(72) Inventors: Michael Bronstein, Lugano (CH); Federico Monti, Cassina Rizzardi (CO) (IT); Xavier Bresson, Singapore (SG)

(21) Appl. No.: 15/952,984

(22) Filed: Apr. 13, 2018

(51) Int. Cl. G06N 3/04; G06F 17/30

(52) U.S. Cl. CPC G06N 3/0454; G06F 17/30867; G06N 3/04; G06N 3/0445; G06F 17/3053

(57) ABSTRACT

Systems and method for producing a recommendation of a plurality of items to a plurality of users are provided. A method for producing a recommendation of a plurality of items to a plurality of users can include: obtaining a subset of multi-dimensional tensor elements representing scores given to a subset of items by a subset of users; obtaining a plurality of geometric domains corresponding to a subset of the dimensions of said multi-dimensional tensor; computing multi-dimensional tensor features by applying at least a multi-domain intrinsic convolutional layer on the multi-dimensional tensor elements; computing a full set of multi-dimensional tensor elements from the multi-dimensional tensor features; and using said full set of multi-dimensional tensor elements to determine recommendation of said plurality of items to said plurality of users.

### BACKGROUND

### Prior Art

Recommender systems have become a central part of modern intelligent systems. Recommending movies on Netflix, friends on Facebook, furniture on Amazon, jobs on LinkedIn are a few examples of the main purpose of these systems. Two major approach to recommender systems are collaborative and content filtering techniques (a reference is made to Breese, J., Heckerman, D., and Kadie, C. Empirical Analysis of Predictive Algorithms for Collaborative Filtering, In Conference on Uncertainty in Artificial Intelligence, pp. 43-52, 1998, and Pazzani, M. and Billsus, D. Content-based Recommendation Systems. The Adaptive Web, pp. 325-341, 2007).

Systems based on collaborative filtering use collected ratings of products by customers and offer new recommendations by finding similar rating patterns. Systems based on content filtering make use of similarities between products and customers to recommend new products. Hybrid systems combine collaborative and content techniques.

Mathematically, a recommendation method can be posed as a matrix completion problem where the columns and rows of a matrix (two-dimensional array of numbers) represent users and items, respectively, and matrix values represent a score determining whether a user would like an item or not. Given a small subset of known elements of the matrix, the goal is to fill in the rest. A famous example is the “Netflix challenge” offered in 2009 and carrying a 1 M$ prize for the algorithm that can best predict user ratings for movies based on previous ratings. The size of the Netflix is 480 k movies×18 k users (8.5B entries), with only 0.011% known entries (a reference is made to Koren, Y., Bell, R., and Volinsky, C. Matrix factorization techniques for recommender systems. Computer 42(8):30-37, 2009).

The same principles can be applied to problems of recovery of higher-dimensional tensors (arrays of numbers), of which matrices are particular instances (two-dimensional tensors). In the following, the term “multi-dimensional tensor” is used to denote such arrays, referring in particular to matrices.

Recently, there have been several attempts to incorporate geometric structure into matrix completion problems, e.g. in the form of column and row graphs representing similarity of users and items, respectively (a reference is made to Ma, H., Zhou, D., Liu, C., Lyu, M., King, I. Recommender systems with social regularization. In Proc. Web Search and Data Mining, 2011; Kalofolias, V., Bresson, X., Bronstein, M. M., Vandergheynst, P. Matrix completion on graphs. arXiv:1408.1717, 2014; Rao, N., Yu, H.-F., Ravikumar, P. K., Dhillon, I. S. Collaborative filtering with graph information: Consistency and scalable methods. In Proc. NIPS, 2015; and Kuang, D., Shi, Z., Osher, S., and Bertozzi, A. A harmonic extension approach for collaborative ranking. arXiv:1602.05127, 2016). Such additional information makes well-defined e.g. the notion of smoothness of data and was shown beneficial for the performance of recommender systems.

These approaches can be generally related to the field of signal processing on graphs and geometric deep learning, extending classical harmonic analysis and deep learning methods to non-Euclidean domains such as graphs and manifolds (a reference is made to Shuman, D. I., Narang, S. K., Frossard, P., Ortega, A., Vandergheynst, P. The emerging field of signal processing on graphs: Extending high-dimensional data analysis to networks and other irregular domains. IEEE Signal Processing Magazine, 30(3):83-98, 2013; and Bronstein, M. M., Bruna, J., LeCun, Y., Szlam, A., Vandergheynst, P. Geometric deep learning: going beyond Euclidean data. arXiv:1611.08097, 2016).

Hereinafter, the term “geometric domain” may refer to continuous non-Euclidean structures such as Riemannian manifolds, or discrete structures such as directed-, undirected-, and weighted graphs or meshes.

Of key interest to the design of recommender systems are deep learning approaches. In the recent years, deep neural networks and, in particular, convolutional neural networks (CNNs), introduced by Lecun et al. (a reference is made to LeCun, Y., Bottou, L., Bengio, Y., Haffner, P. Gradient-based learning applied to document recognition. Proc. IEEE, 86(11):2278-2324, 1998) have been applied with great success to numerous computer vision-related applications.

A prototypical CNN architecture consists of a sequence of convolutional layers applying a bank of learnable filters to the input, interleaved with pooling layers reducing the dimensionality of the input. A convolutional layer output is computed using the convolution operation, which is defined on domains with shift-invariant structure (in discrete setting, regular grids).

However, original CNN models cannot be directly applied to the recommendation problem to extract meaningful patterns in users, items and ratings because these data are not Euclidean-structured, i.e. they do not lie on regular grids like images but irregular domains like graphs or manifolds. This strongly motivates the development of geometric deep learning techniques that can mathematically deal with graph-structured data, which arises in numerous applications, ranging from computer graphics to chemistry.

The earliest attempts to apply neural networks to graphs are due to Scarselli et al. (a reference is made to Scarselli, F., Gori, M., Tsoi, A. C., Hagenbuchner, M., Monfardini, G. The graph neural network model. IEEE Transactions on Neural Networks 20(1):61-80, 2009).

Bruna et al. (a reference is made to Bruna, J., Zaremba, W., Szlam, A., and LeCun, Y. Spectral networks and locally connected networks on graphs. Proc. ICLR 2014) formulated CNN-like deep neural architectures on graphs in the spectral domain, employing the analogy between the classical Fourier transforms and projections onto the eigenbasis of the graph Laplacian operator.

In a follow-up work, Defferrard et al. (a reference is made to Defferrard, M., Bresson, X., and Vandergheynst, P. Convolutional neural networks on graphs with fast localized spectral filtering. In Proc. NIPS 2016) proposed an efficient filtering scheme using recurrent Chebyshev polynomials, which reduces the complexity of CNNs on graphs to the same complexity of standard CNNs on regular Euclidean domains.

Kipf and Welling (a reference is made to Kipf, T. N. and Welling, M. Semi-supervised classification with graph convolutional networks. arXiv:1609.02907, 2016) proposed a simplification of Chebychev networks using simple filters operating on 1-hop neighborhoods of the graph.

Monti et al. (a reference is made to Monti, F, Boscaini, D., Masci, J., Rodola, E., Bronstein, M. M. Geometric deep learning on graphs and manifolds using mixture model CNNs. Proc. CVPR 2017) introduced a spatial-domain generalization of CNNs to graphs using local patch operators represented as Gaussian mixture models, showing a significant advantage of such models in generalizing across different graphs.

The problem at the base of the present invention is to provide a method based on a deep learning technique which may be directly applied to the recommendation problem for extracting much more meaningful patterns in users with respect to the patterns provided with prior art techniques, wherein patterns are actions which are expected to be taken by a user, for example through the Internet, such as ordering a product or service, based on previously actions taken by the user.

### BRIEF SUMMARY

The idea of solution at the base of the present invention is to associate a recommendation problem to a matrix completion problem as geometric deep learning on non-Euclidean geometric domains (in particular, graphs).

The result of the matrix completion problem seeks to predict the “rating” or “preference” that a user would give to an item and may be given to a recommender system to improve the user experience and purchase of products or services.

On the base of this idea of solution, the technical problem mentioned above is solved by a method for estimating the elements of a matrix (or more generally, a multi-dimensional tensor), comprising the steps of inputting a subset of the known matrix elements together with a plurality of geometric domains corresponding to the dimensions of said matrix (for example, such domains being column- and row graphs); computing matrix features by applying a multi-domain intrinsic convolutional neural network (consisting of at least one intrinsic convolutional layer) on the matrix elements; and finally computing the matrix elements from the matrix features.

There is further provided, in accordance with some embodiments of the present invention, a data processing system comprising a processing unit in communication with a computer usable medium, wherein the computer usable medium contains a set of instructions. The processing unit is designed to carry out the set of instructions to: obtain a subset of multi-dimensional tensor elements representing scores given to a subset of items by a subset of users; obtain a plurality of geometric domains corresponding to a subset of the dimensions of said multi-dimensional tensor; computing multi-dimensional tensor features by applying at least a multi-domain intrinsic convolutional layer on the multi-dimensional tensor elements; computing a full set of multi-dimensional tensor elements from the multi-dimensional tensor features, using said full set of multi-dimensional tensor elements to output recommendation of a plurality of items to a plurality of users.

More particularly, it is the computer system that takes as input said subset of the known matrix elements together with said plurality of geometric domains corresponding to the dimensions of the matrix, computes said matrix features by applying the multi-domain intrinsic convolutional neural network on the matrix elements; and computes said matrix elements from the matrix features.

Therefore, although not explicitly mentioned, all the method steps disclosed hereafter are implemented in the computer system.

Advantageously, by executing the method claimed in the present invention, the computer system may provide a more precise prediction on “rating” or “preference” that a user would give to an item, i.e. it provides the best accuracy to the recommendation system. More particularly, preferences estimated by the method of the present invention for users, before such users give their preferences to items, are much more close to the preferences really given by the user, after estimation (a probability that a user gives his preference to an item estimated by the method of the present invention is higher than a probability that a user gives his preference to an item estimated by a method according to the prior art).

Still advantageously, the method according to the present invention has lower complexity than prior art methods used to solve recommendation problems, and therefore may be completed by processing means of a computer system is a shorter time or by using less computing resources with respect to a method according to the prior art.

A neural network architecture is proposed that is able to extract local stationary patterns (acting as aforementioned matric features) from a matrix whose columns and rows are given on such domains, and use these meaningful features to infer the non-linear temporal diffusion mechanism of the matrix values. Local patterns are associated to known preferences or rates given by users in the past.

These spatial patterns are extracted by a special convolutional architecture referred to as multi-domain intrinsic convolutional neural network (MD-ICNN) or multi-graph intrinsic convolutional neural network (MG-ICNN) in the case when the geometric domains are graphs) designed to work on multiple non-Euclidean geometric domains. The multi-domain intrinsic CNN learns tasks-specific features from matrix (or more generally, tensor) data whose dimensions are given on different geometric domains. The diffusion of the matrix elements is produced by a recurrent process, that can further be learnable. In particular, a Long-Short Term Memory (LSTM) recurrent neural network (RNN), such as the architecture introduced in Hochreiter, S. and Schmidhuber, J. Long short-term memory. Neural Computation, 9(8):1735-1780, 1997, can be used.

In the context of recommendation systems, the proposed method is applied on a set of scores given by users to items that constitute a subset of elements of the score matrix and row- and column graphs representing the relations between items and users respectively, with the goal to estimate the missing elements of the score matrix.

A matrix element computed from the matrix features, corresponding to a missing element of the score matrix, represents the score of an item to which a user has not previously given a score, and is provided to the recommender system, to the end that the user may be recommended with such an item with the computed score. In one embodiment of the invention, elements of the matrix are sorted according to their highest predicted scores and a list of the first top-scored items is provided.

### BRIEF DESCRIPTION OF THE DRAWINGS

FIG. 1 depicts the basic matrix completion problem arising in recommendation systems, where a subset of known elements (scores given by users to items) is given and the rest of the elements must be estimated.

FIG. 2 depicts a geometric matrix completion problem arising in recommendation systems, where in addition the relations between users are given in the form of user (column) graph, and smoothness prior can be imposed on the elements of the score matrix, demanding that columns representing the scores of related users are similar.

FIG. 3 depicts a geometric matrix completion problem arising in recommendation systems, where the relations both between users and items are given in the form of user (column) and item (row) graphs, and smoothness prior can be imposed on the elements of the score matrix, demanding that columns representing the scores of related users are similar as well as that rows representing the scores of related items are similar.

FIG. 4 depicts a factorized form of the geometric matrix completion arising in recommendation systems, where the score matrix is given as a product of column- and row factors.

FIG. 5 depicts the process of matrix completion according to one of the embodiments of the invention, in which a non-factorized matrix model is used.

FIG. 6 depicts the process of matrix completion according to one of the embodiments of the invention, in which a factorized matrix model is used.

FIG. 7 depicts a high-level flow diagram of a method for estimating the elements of a d-dimensional tensor.

FIG. 8 depicts the flow diagram of one of the embodiments of the invention applied to a multi-dimensional tensor completion problem.

FIG. 9 depicts the flow diagram of one of the embodiments of the invention applied to a multi-dimensional tensor completion problem.

FIG. 10 depicts such a combination of the embodiments of FIGS. 8 and 9 on a three-dimensional tensor completion problem.

### DETAILED DISCLOSURE

Matrix Completion.

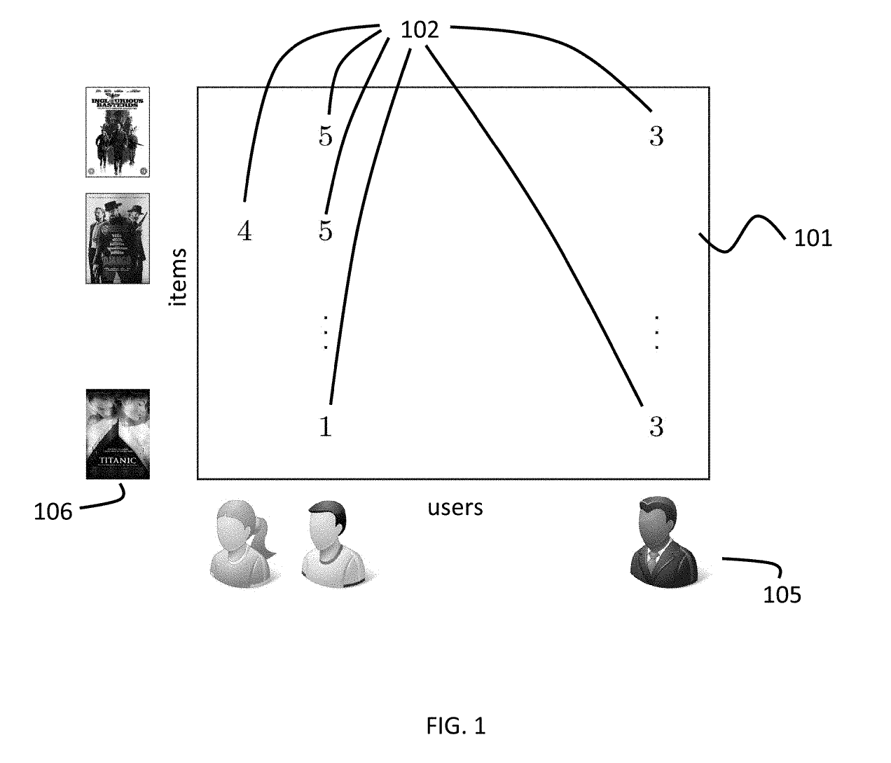

Referring to FIG. 1, the problem of matrix completion consists of, given a matrix 101 with only a subset of known elements 102, recovering the rest of the elements of matrix 101. In the context of a recommendation system, the depicted matrix 101 represents scores given by users 105 to different items (e.g. movies) 106; a column of the matrix 101 corresponds to a user and a row thereof to an item.

Recovering the missing values of a matrix given a small fraction of its entries is an ill-posed problem without additional mathematical constraints on the space of solutions. A well-posed problem is to assume that the variables lie in a smaller subspace, i.e., that the matrix is of low rank, and to recover the missing elements by solving the optimization problem (1)

$${min}_{X} rank ( X ) s . t . {x}_{ij} = {y}_{ij} ∀ ij ∈ Ω \qquad ( 1 )$$

where X is a mathematical notation for the matrix 101 to recover, Ω is the set of the known elements 102 and yᵢⱼ are their values. The formulation in problem (1) keeps the known elements fixed and allows to modify only the rest of the elements.

To make equation (1) robust against noise and perturbation, the equality constraint can be replaced with a penalty

$${min}_{X} rank ( X ) + \frac{μ}{2} {‖ Ω ∘ ( X - Y ) ‖}_{F}^{2} \qquad ( 2 )$$

where Ω is the indicator matrix of the known entries Ω and ∘ denotes the Hadamard element-wise matrix product.

The formulation of equation (2) allows all the elements of the matrix to be modified by the optimization procedure. It is understood that the term “matrix completion” may refer to both formulations of type (1) or (2).

Unfortunately, rank minimization turns out an NP-hard combinatorial problem that is computationally intractable in practical cases. The tightest possible convex relaxation of the previous problem is

$${min}_{X} {‖ X ‖}_{*} + \frac{μ}{2} {‖ Ω ∘ ( X - Y ) ‖}_{F}^{2} \qquad ( 3 )$$

where ∥ ∥_{*} is the nuclear norm of a matrix equal to the sum of its singular values. Candes and Recht (a reference is made to Candes, E., Recht, B., Exact matrix completion via convex optimization. Communications of ACM 55(6):111-119, 2012) proved that under certain conditions, solving problem (3) leads to solutions that coincide with the original problem (2).

Geometric Matrix Completion.

An alternative relaxation of the rank operator in problems (1) or (2) is to constraint the space of solutions to be smooth w.r.t. some geometric structure defined on the matrix rows and columns. Such a problem is referred to as geometric matrix completion.

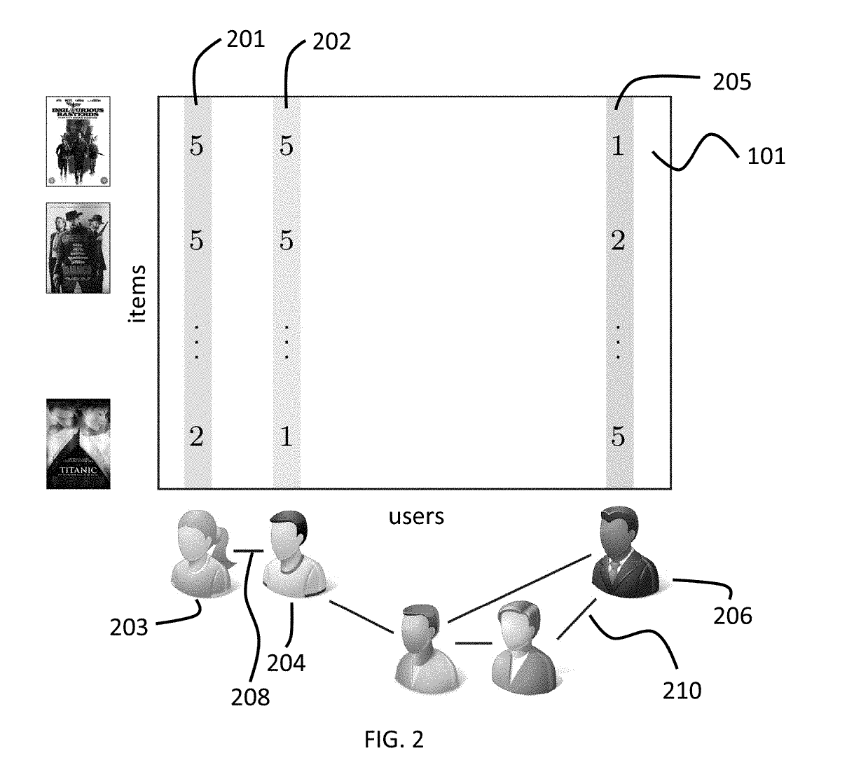

The simplest model, depicted in FIG. 2, is a proximity structure represented as an undirected weighted column graph 210. In the context of a recommendation system, graph 210 could represent some similarity of users' tastes or a social network capturing e.g. friendship relations between users. Relationship between related users 203 and 204 is represented by the presence of an edge 208 in the user graph 210 (conversely, for a different user 206 unrelated to users 203 and 204, there is no edge in the graph 210). Each edge could be possibly weighted, with the weight numerically representing the strength of the relation.

Columns 201, 202, and 205 of the score matrix 101 represent the scores given to the items by users 203, 204, and 206, respectively. The (column-wise matrix) smoothness assumption implies that columns 201 and 202 of the score matrix 101 corresponding to related users 203 and 204 would have similar score values, while column 205 corresponding to an unrelated user 206 might have different score values.

Mathematically, the (undirected) column graph is given by [symbol] _{c}=(ν_{c}32 {1, . . . , n}, ε_{c},w_{c}), where n is the number of matrix columns, ν_{c} is the set of vertices, ε_{c}⊆ν_{c}×ν_{c} is the set of edges, and w_{c}, is the n×n matrix of non-negative edge weights, where the convention is that w_{cij}=0 iff ij∉ε_{c}.

The graph can be given (e.g. in case a social network of users is known), computed from some user-related metadata (e.g. demographic information including age, sex, etc.), or computed from the data itself (e.g. by computing a metric between the overlapping elements of each pair of matrix columns).

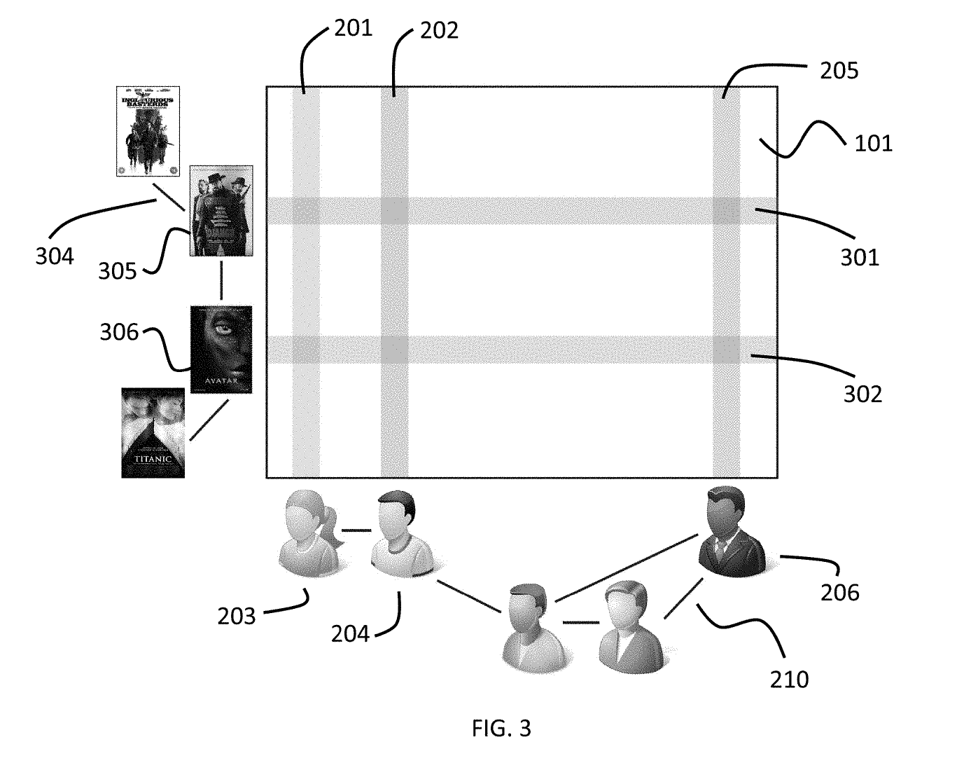

FIG. 3 depicts a generalization of this model, where additional proximity structure between the rows of the matrix is given in the form of a row graph 304. In the context of a recommendation system, graph 304 could represent some similarity of the items (e.g., considering the example of movies, two movies would be related if they share the same genre or the same director). In this setting, the smoothness assumption can be applied row- and column-wise; row-wise smoothness implies that rows 301 and 302 of score matrix 101 corresponding to related items 305 and 306 would contain similar values.

The row graph is similarly denoted by [symbol] ᵣ=(νᵣ={1, . . . , m}, εᵣ, wᵣ), where m is the number of matrix rows.

On each of the graphs, one can construct the (unnormalized) graph Laplacian, a symmetric positive-semidefinite matrix Δ=I−D^{-1/2}WD^{-1/2} where D=diag(Σ_{j≠i} wᵢⱼ) is the degree matrix. The Laplacians associated with row and column graphs are m×m and n×n matrices denoted by Δᵣ and Δ_{c}, respectively. Different definitions of graph Laplacians used in the literature can be applied as well.

Considering the columns (respectively, rows) of matrix X as vector-valued functions on the column graph [symbol] _{c} (respectively, row graph [symbol] ᵣ), their smoothness can be expressed as the Dirichlet norm (or energy) [symbol] =trace(X^{T}ΔᵣX) (respectively, [symbol] =trace(XΔ_{c}X^{T})).

The geometric matrix completion problem boils down to minimizing

$${min}_{X} {‖ X ‖}_{{𝒢}_{c}}^{2} + {‖ X ‖}_{{𝒢}_{r}}^{2} + \frac{μ}{2} {‖ Ω ∘ ( X - Y ) ‖}_{F}^{2} \qquad ( 4 )$$

and can be interpreted as finding the smoothest (row- and column-wise, w.r.t the the respective graphs) matrix fitting the data.

Factorized Matrix Completion.

Matrix completion problems of the form (3) are well-posed as convex optimization problems, guaranteeing existence, uniqueness and robustness of solutions. Besides, fast algorithms have been developed in the context of compressed sensing to solve the non-differential nuclear norm problem. However, the variables in this formulation are the full m×n matrix X, making such methods hard to scale up to large matrices such as the notorious Netflix challenge.

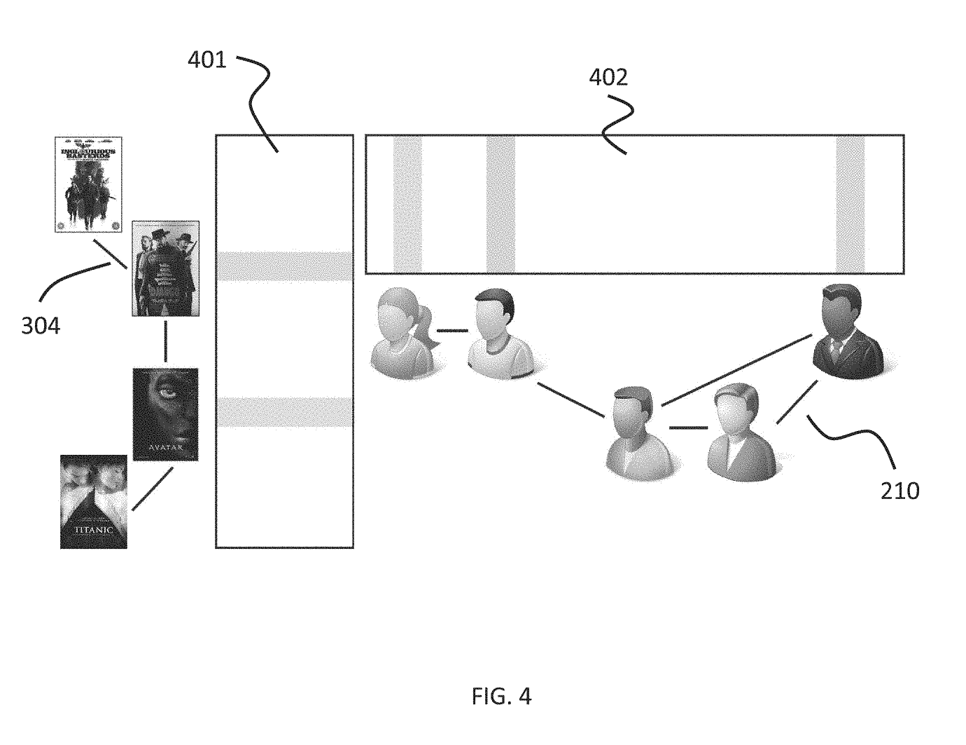

A solution is to use a factorized representation X=WH^{T} (a reference is made to N. Srebro, J. Rennie, T. Jaakkola, Maximum-Margin Matrix Factorization. In Proc. NIPS 2004), where W and H are m×r and n×r matrices, respectively, and r<<max(m,n). FIG. 4 depicts the factorized form of the score matrix X given by the product of factors 401 and 402.

The use of factors W, H allows to reduce the number of degrees of freedom from O(mn) to O(m+n); this representation is also attractive as solving the matrix completion problem often assumes the original matrix to be low-rank, and rank(WH^{T})≤r by construction.

The nuclear norm minimization problem (3) can be rewritten in a factorized form as

$${min}_{H , W} \frac{1}{2} {‖ W ‖}_{F}^{2} + \frac{1}{2} {‖ H ‖}_{F}^{2} + \frac{μ}{2} {‖ Ω ∘ ( {WH}^{T} - Y ) ‖}_{F}^{2} \qquad ( 5 )$$

(a reference is made to N. Srebro, J. Rennie, T. Jaakkola, Maximum-Margin Matrix Factorization. In Proc. NIPS 2004).

Similarly, the geometric matrix completion problem (4) can be rewritten in a factorized form as

$${min}_{H , W} {‖ H ‖}_{{𝒢}_{c}}^{2} + {‖ W ‖}_{{𝒢}_{r}}^{2} + \frac{μ}{2} {‖ Ω ∘ ( {WH}^{T} - Y ) ‖}_{F}^{2} \qquad ( 6 )$$

(a reference is made to N. Rao, H.-F. Yu, P. K. Ravikumar, and I. S. Dhillon, Collaborative filtering with graph information: Consistency and scalable methods. In Proc. NIPS 2015).

Deep Learning on Graphs.

The key concept underlying the invention is geometric deep learning, an extension of convolutional neural networks to geometric domains, in particular, to graphs. Such neural network architectures are known under different names, and are referred to as intrinsic CNNs (ICNNs) here. In particular, our main focus in on their special instance, graph CNNs formulated in the spectral domain, though additional methods were proposed in literature (a reference is made to M. M. Bronstein, J. Bruna, Y. LeCun, A. Szlam, P. Vandergheynst, Geometric deep learning: going beyond Euclidean data, IEEE Signal Processing Magazine 34(4): 18-42, 2017) and can be applied to the present invention by a person skilled in art.

A graph Laplacian admits an eigen decomposition of the form Δ=ΦΛΦ^{T}, where Φ=(ϕ₁, . . . ϕₙ) denotes the matrix of orthonormal eigenvectors and Λ=diag(λ₁, . . . , λₙ) is the diagonal matrix of the corresponding eigenvalues. The eigenvectors play the role of Fourier atoms in classical harmonic analysis and the eigenvalues can be interpreted as frequencies. Given a function x=(x₁, . . . , xₙ)^{T} on the vertices of the graph, its graph Fourier transform is given by \hat{x}=Φ^{T}x. The spectral convolution of two functions x, y can be defined as the element-wise product of the respective Fourier transforms,

x★k=y=Φ(Φ^{T}y)∘(Φ^{T}x)=diag(ŷ₁, . . . , ŷₙ)\hat{x} (7)

by analogy to the Convolution Theorem in the Euclidean case.

Bruna et al. (a reference is made to J. Bruna, W. Zaremba, A. Szlam, Y. LeCun, Spectral Networks and Locally Connected Networks on Graphs, Proc. ICLR 2014) used the spectral definition of convolution (7) to generalize CNNs on graphs. A spectral convolutional layer in this formulation has the form

$${\tilde{x}}_{l} = ξ ( {\sum }_{{l}^{′} = 1}^{{q}^{′}} Φ {\hat{Y}}_{{ll}^{′}} {Φ}^{⊤} {x}_{{l}^{′}} ) , l = 1 , … , q , \qquad ( 8 )$$

where q′ and q denote the number of input and output channels, respectively, Y_{ll′} is a diagonal matrix of spectral multipliers representing a learnable filter in the spectral domain, and ξ is a nonlinearity (e.g. ReLU) applied on the vertex-wise function values. Such an architecture is referred to as spectral graph CNN. Unlike classical convolutions carried out efficiently in the spectral domain using FFT, the computations of the forward and inverse graph Fourier transform incur expensive O(n²) multiplication by the matrices Φ, Φ^{T}, as there are no FFT-like algorithms on general graphs. Second, the number of parameters representing the filters of each layer of a spectral CNN is O(n), as opposed to O(1) in classical CNNs. Third, there is no guarantee that the filters represented in the spectral domain are localized in the spatial domain, which is another important property of classical CNNs.

Defferrard et al. (a reference is made to M. Defferrard, X. Bresson, P. Vandergheynst, Convolutional Neural Networks on Graphs with Fast Localized Spectral Filtering, Proc. NIPS 2016) used polynomial filters of order p represented in the Chebyshev basis,

$${τ}_{θ} ( \tilde{λ} ) = {\prod }_{j = 0}^{p} {θ}_{j} {T}_{j} ( \tilde{λ} ) , \qquad ( 9 )$$

where \tilde{λ} is frequency resealed in [−1,1], θ is the (p+1)-dimensional vector of polynomial coefficients parametrizing the filter, and Tⱼ(λ)=2λTⱼ₋₁(λ)−Tⱼ₋₂(λ) denotes the Chebyshev polynomial of degree j defined in a recursive manner with T₁(λ)=λ and T₀(λ)=1. Here, \tilde{Δ}=2λₙ⁻¹Δ−I is the resealed Laplacian with eigenvalues \tilde{Λ}=2λₙ⁻¹Λ−I in the interval [−1,1].

This approach benefits from several advantages. First, it does not require an explicit computation of the Laplacian eigenvectors, as applying a Chebyshev filter to x amounts to

τ_{θ}(\tilde{Δ})x=Σⱼ₌₀^{p}θⱼTⱼ(\tilde{Δ})x (10)

due to the recursive definition of the Chebyshev polynomials, this incurs applying the Laplacian p times. Multiplication by Laplacian has the cost of O(|ε|), and assuming the graph has |ε|=O(n) edges (which is the case for k-nearest neighbors graphs and most real-world networks), the overall complexity is O(n) rather than O(n²) operations, similarly to classical CNNs. Moreover, since the Laplacian is a local operator affecting only 1-hop neighbors of a vertex and accordingly its pth power affects the p-hop neighborhood, the resulting filters are spatially localized. Since the eigen decomposition of the Laplacian is not explicitly performed in this architecture, it is called spectrum free graph CNN.

An extension of the Chebyshev filter was proposed by Levie et al. (a reference is made to R. Levie, F. Monti, X. Bresson, M. M. Bronstein, “CayleyNets: Graph convolutional neural networks with complex rational spectral filters”, arXiv:1705.07664, 2017), where rational functions are used in place of polynomials, and the operations applied to the Laplacian include not only matrix-vector multiplication, scalar multiplication, and addition, but also matrix inversion. Levie et al. show that the matrix inversion can be approximated with O(n) complexity using an iterative method, e.g., Jacobi iteration.

Another extension of the Chebyshev filter was proposed by Monti et al. (a reference is made to F. Monti, K. Otness, M. M. Bronstein, “MotifNet: a motif-based Graph Convolutional Network for directed graphs”, arXiv:1802.01572, 2018) to deal with directed graphs. Monti et al. consider small sub-graph structures (known as graphlets or graph motifs) and construct motif Laplacians for each of such structures (a reference is made to A. R. Benson, D. F. Gleich, J. Leskovec, “Higher-order organization of complex networks,” Science 353(6295):163-166, 2016).

A different class of graph CNNs called spatial graph CNNs was proposed by Monti et al. (a reference is made to F. Monti, D. Boscaini, J. Masci, E. Rodolà, J. Svoboda, M. M. Bronstein, “Geometric deep learning on graphs and manifolds using mixture model CNNs”, arXiv:1611.08402, 2016). The key idea of such approaches is to construct a local system of coordinates in a neighbourhood around each vertex of the graph, and then map the neighbour vertices into these coordinates, resulting in a local patch. Then, convolution on the graph can be to represented as a filter applied to to the patch. In particular, Monti et al. used a mixture of Gaussians to represent the filters.

Multi-Graph CNNs.

Our first goal is to extend the notion of the aforementioned graph Fourier transform to matrices whose rows and columns are defined on row- and column-graphs. We recall that the classical two-dimensional Fourier transform of an image (matrix) can be thought of as applying a one-dimensional Fourier transform to its rows and columns. In our setting, the analogy of the two-dimensional Fourier transform has the faun

\hat{X}=Φᵣ^{T}XΦ_{c} (11)

where Φ_{c}, Φᵣ, and Λ_{c}=diag(λ_{c,1}, . . . , λ_{c,n}) and Λᵣ=diag(λ_{r,1}, . . . , λ_{r,m}) denote the n×n and m×m eigenvector- and eigenvalue matrices of the column- and row-graph Laplacians Δ_{c}, Δᵣ respectively. The multi-graph version of the spectral convolution (7) is given by

X★Y=Φᵣ(\hat{X}∘Ŷ)Φ_{c}^{T} (12)

and in the classical setting can be thought as the analogy of filtering a 2D image in the spectral domain (column and row graph eigenvalues λ_{c} and λᵣ generalize the x- and y-frequencies of an image).

Representing multi-graph filters as their spectral multipliers would yield O(mn) parameters, prohibitive in any practical application. To overcome this limitation, we assume that the multi-graph filters are expressed in the spectral domain as a smooth function of both frequencies (eigenvalues λ_{c} and λᵣ of the row- and column graph Laplacians) of the form Ŷ_{knk′}=τ(λ_{c,k}, λ_{r,k′}). In particular, using Chebyshev polynomial filters of degree p,

$${τ}_{Θ} ( {\tilde{λ}}_{c} , {\tilde{λ}}_{r} ) = {\sum }_{j , {j}^{′} = 0}^{p} {θ}_{{jj}^{′}} {T}_{j} ( {\tilde{λ}}_{c} ) {T}_{{j}^{′}} ( {\tilde{λ}}_{r} ) \qquad ( 13 )$$

where \tilde{λ}_{c}, \hat{λ}ᵣ are the frequencies resealed [−1,1]. Such filters are parametrized by a (p+1)×(p+1) matrix of coefficients Θ, which is O(1) in the input size as in classical CNNs on images. The application of a multi-graph filter to the matrix X

$$\tilde{X} = {\sum }_{j , {j}^{′} = 0}^{p} {θ}_{{jj}^{′}} {T}_{j} ( {\tilde{Δ}}_{r} ) {XT}_{{j}^{′}} ( {\tilde{Δ}}_{c} ) \qquad ( 14 )$$

incurs an only O(mn) computational complexity.

Similarly to (8), a multi-graph convolutional layer using the parametrization of filters according to (14) is applied to q′ input channels (m×n matrices X₁, . . . , X_{q′} or a tensor of size m×n×q′),

$${\tilde{X}}_{l} = ξ ( {\sum }_{{l}^{′} = 1}^{{q}^{′}} {X}_{{l}^{′}} * {Y}_{{ll}^{′}} ) = ξ ( {\sum }_{{l}^{′} = 1}^{{q}^{′}} {\sum }_{j , {j}^{′} = 0}^{p} {θ}_{j , {j}^{′} , {ll}^{′}} {T}_{j} ( {\tilde{Δ}}_{r} ) {X}_{{l}^{′}} {T}_{{j}^{′} } ( {\tilde{Δ}}_{c} ) ) , \\ l = 1 , … , q , \qquad ( 15 )$$

producing q outputs (tensor of size m×n×q). Several layers can be stacked together. We call such an architecture a Multi-Graph Instrinsic CNN (MG-ICNN) or more generally, a Multi-Domain ICNN (MD-ICNN).

A simplification of the multi-graph convolution is obtained considering the factorized form of the matrix X=WH^{T} and applying one-dimensional convolutions to the respective graph to each factor. Similarly to the previous case, we can express the filters resorting to Chebyshev polynomials,

$${\tilde{w}}_{l} = {\sum }_{j = 0}^{p} {θ}_{j}^{r} {T}_{j} ( {\tilde{Δ}}_{r} ) {w}_{l} , {\tilde{h}}_{l} = {\sum }_{{j}^{′} = 0}^{p} {θ}_{{j}^{′}}^{c} {T}_{{j}^{′}} ( {\tilde{Δ}}_{c} ) {h}_{l} , l = 1 , … , r \qquad ( 16 )$$

where wₗ, hₗ denote the lth columns of factors W, H and θ^{r}=(θ₀^{r}, . . . , θₚ^{r}) and θ^{c}(θ₀^{c}, . . . , θₚ^{c}) are the parameters of the row- and column-filters, respectively (a total of 2(p+1)=O(1)). Application of such filters to W and H incurs O(m+n) complexity. Convolutional layers (14) thus take the form

$${\tilde{w}}_{l} = ξ ( {\sum }_{{l}^{′} = 1}^{{q}^{′}} {\sum }_{j = 0}^{p} {θ}_{j , {ll}^{′}}^{r} {T}_{j} ( {\tilde{Δ}}_{r} ) {w}_{{l}^{′}} ) , {\tilde{h}}_{l} = ξ ( {\sum }_{{l}^{′} = 1}^{{q}^{′}} {\sum }_{{j}^{′} = 0}^{p} {θ}_{{j}^{′} , {ll}^{′}}^{c} {T}_{{j}^{′}} ( {\tilde{Δ}}_{c} ) {h}_{{l}^{′}} ) \qquad ( 17 )$$

We call such an architecture a Separable MD-ICNN.

In the following, the general term Multi-domain or Multi-graph ICNN can be used interchangeably referring to both separable and non-separable Multi-domain ICNNs.

Matrix Diffusion with RNN.

The next step of our approach is to feed the spatial features extracted from the matrix by the MG-ICNN or Separable MG-ICNN to a recurrent neural network (RNN) implementing a diffusion process that progressively reconstructs the score matrix. Modelling matrix completion as a diffusion process appears particularly suitable for realizing an architecture, which is independent of the sparsity of the available information. In order to combine the few scores available in a sparse input matrix, a multilayer CNN would require very large filters or many layers to diffuse the score information across matrix domains. On the contrary, our diffusion-based approach allows to reconstruct the missing information just by imposing the proper amount of diffusion iterations. This gives the possibility to deal with extremely sparse data, without requiring at the same time excessive amounts of model parameters.

In one of the preferred embodiments of the invention, an LSTM architecture, which has demonstrated to be highly efficient to learn complex non-linear diffusion processes due to its ability to keep long-term internal states (in particular, limiting the vanishing gradient issue). The input of the LSTM gate is given by the static features extracted from the MG-ICNN, which can be seen as a projection or dimensionality reduction of the original matrix in the space of the most meaningful and representative information (the disentanglement effect). This representation coupled with LSTM appears particularly well-suited to keep a long term internal state, which allows to predict accurate small changes dX of the matrix X (or dW, dH of the factors W, H) that can propagate through the full temporal steps.

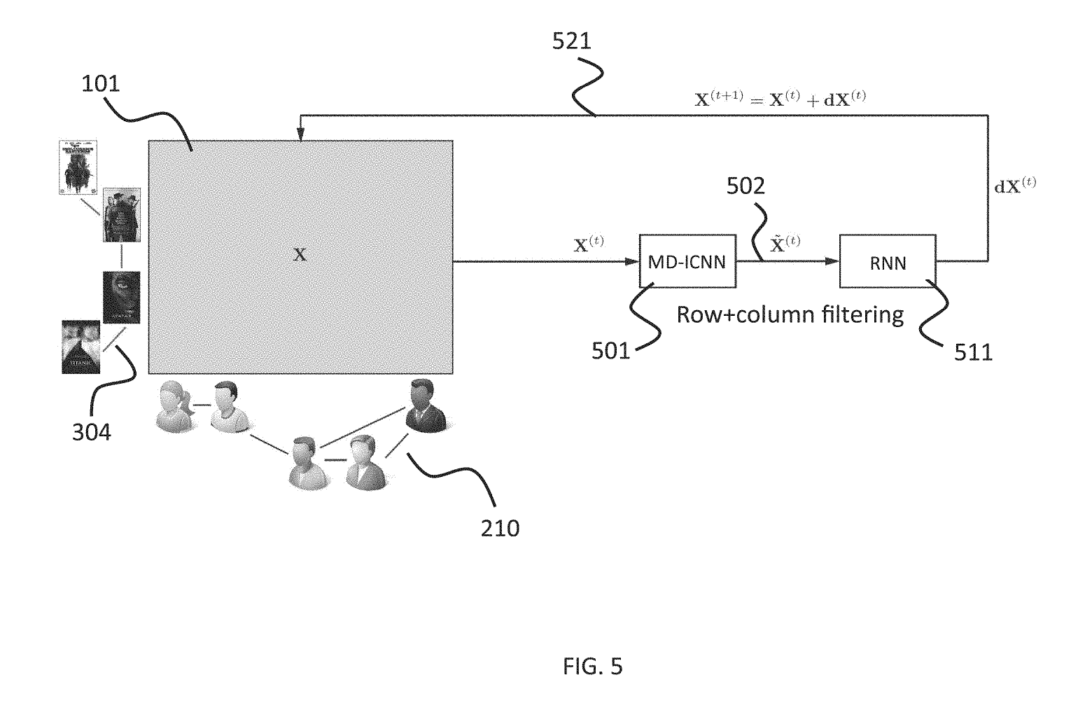

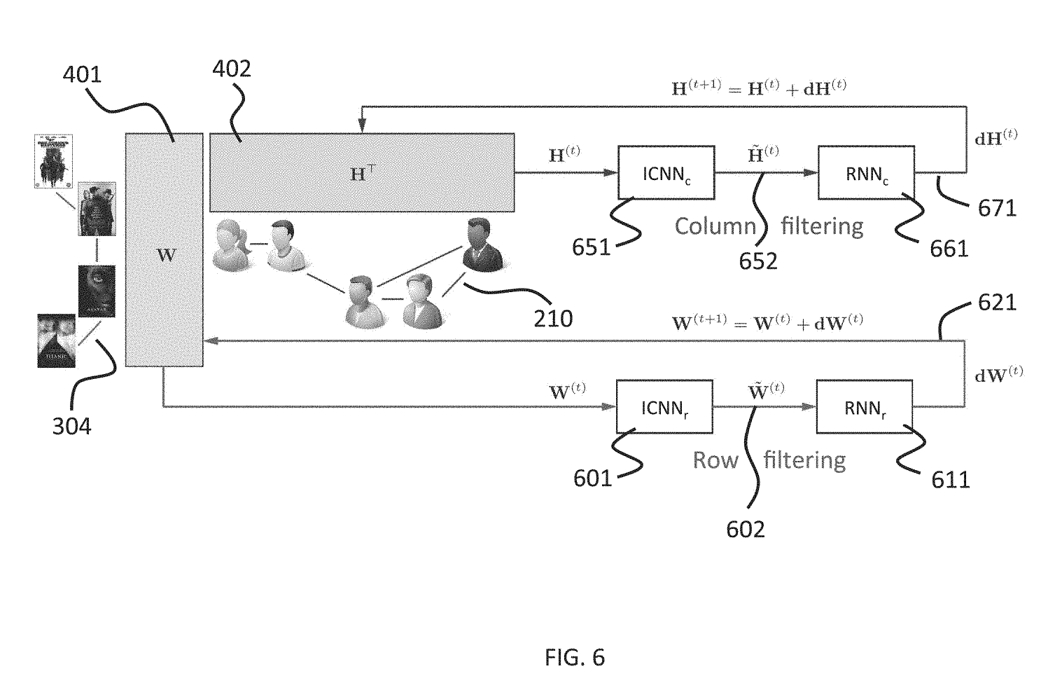

FIG. 5 and FIG. 6 depict some embodiments of the aforementioned matrix completion architectures. We refer to the whole architecture combining the MD-ICNN and RNN in the full matrix completion setting as Recurrent Multi-Graph or Multi-Domain Intrinsic CNN (RMD-ICNN).

Training.

Training of the networks is performed by minimizing the loss

$$𝓁 ( Θ , σ ) = {‖ {X}_{Θ , σ}^{( T )} ‖}_{{𝒢}_{r}}^{2} + {‖ {X}_{Θ , σ}^{( T )} ‖}_{{𝒢}_{c}}^{2} + \frac{μ}{2} {‖ Ω ∘ ( {X}_{Θ , σ}^{T} - Y ) ‖}_{F}^{2} \qquad ( 18 )$$

Here, T denotes the number of diffusion iterations (applications of the RNN), and we use the notation X_{Θ, σ}^{(T)} to emphasize that the matrix depends on the parameters of the MD-ICNN (Chebyshev polynomial coefficients Θ) and those of the LSTM (denoted by σ). In the factorized setting, we use the loss

$$𝓁 ( {θ}_{r} , {θ}_{c} , σ ) = {‖ {W}_{{θ}_{r} , σ}^{( T )} ‖}_{{𝒢}_{r}}^{2} + {‖ {H}_{{θ}_{c} , σ}^{( T )} ‖}_{{𝒢}_{c}}^{2} + \frac{μ}{2} {‖ Ω ∘ ( {{W}_{{θ}_{r} , σ}^{( T )} ( {H}_{{θ}_{c} , σ}^{( T )} )}^{⊤} - Y ) ‖}_{F}^{2} \qquad ( 19 )$$

where θ_{c}, θᵣ are the parameters of the two GCNNs.

### DESCRIPTION OF THE PREFERRED EMBODIMENTS

FIGS. 5 and 6 depict the application of some embodiments of the invention to the geometric matrix completion problem arising in recommendation systems, such as recommending movies to users. The geometric domains in the examples depicted in FIGS. 5 and 6 are user and movie graph; these examples should not be restrictive, and the term geometric domains should be interpreted in a broad sense. It is implied that the invention can be applied by a person skilled in art to the problem where the term “geometric domain” may refer to, among others, directed or undirected graphs, point clouds in some high-dimensional space, manifolds, meshes, or implicit surfaces.

In one of the preferred embodiments of the invention depicted in FIG. 5, a non-factorized matrix representation is used. A Multi-Domain Intrinsic CNN (MD-ICNN) 501 is applied to the initial score matrix 101 in order to extract a set of matrix features 502 capturing the structure of the user scores. The matrix features 502 are fed into a Recurrent Neural Network (RNN) 511 generating an incremental update 521 of the score matrix. The incremental update 521 is added to the current estimate of the matrix 101, producing an improved estimate thereof. The process is repeated several times using the matrix estimate produced by the previous step as the input.

In one of the preferred embodiments of the invention depicted in FIG. 6, a factorized matrix representation is used, wherein the score matrix is given in the form of a product of column factor 401 and row factor 402. Each of the factors is treated independently and possibly in parallel. A single-domain row Intrinsic CNN (ICNN) 601 is applied to the initial row factor 401 in order to extract a set of row factor features 602. The row factor features 602 are fed into a row RNN 611 generating an incremental update 621 of the row factor. The incremental update 621 is added to the current estimate of the row factor 401, producing an improved estimate thereof.

In a similar manner, a single-domain column Intrinsic CNN (ICNN) 651 is applied to the initial column factor 402 in order to extract a set of column factor features 652. The column factor features 652 are fed into a column RNN 661 generating an incremental update 671 of the column factor. The incremental update 671 is added to the current estimate of the column factor 402, producing an improved estimate thereof.

A current estimate of the score matrix is produced by computing the product of the current estimates of the column factor 401 and row factor 402. The process is repeated several times using the factor estimates produced by the previous step as the input.

Though the embodiments depicted in FIGS. 5 and 6 depict given geometric domains, in some embodiments only some or none of the geometric domains can be provided as input, and some of the geometric domains can be inferred from the data or additional side information.

For example, in the embodiment depicted in FIG. 6, only one of the column or row graph can be provided as input, and the other graph (row or column, respectively) is not given. In this setting, the factor for which the graph is provided as input is treated according to the aforementioned description using an Intrinsic CNN, while the other factor for which the graph is not provided is treated as a free factor in traditional matrix completion problems according to equations (5) or (6).

Alternatively, the non-provided geometric domains can be constructed from the data. In one embodiment of the invention, a distance is computed between the rows or columns of the score matrix corresponding to the non-provided domain; such a distance accounts for the missing elements of the score matrix. In the simplest setting, the distance between two rows or columns may be computed as the Euclidean distance between the intersection of the subsets of elements present in both of said rows or columns.

In another embodiment of the invention, additional side information is provided in the form of user or item features. For example, user features may include sex, age, educational background, etc., and item features in the example of movies may include the genre, director, and production year. The missing user or item graphs are then constructed using a metric in the respective user or item feature space; the metric can be parametric (e.g. Mahalanobis metric in the simplest case, or a small neural network) and its parameters included as optimization variables in the training procedure.

In another embodiment of the invention, the entire missing graph can be included into the training procedure, providing the edge weights as the optimization variables.

Though the embodiments depicted in FIGS. 5 and 6 are exemplified on the problem of matrix completion, it is implied that the invention can be applied by a person skilled in art to the problem of multi-dimensional tensor completion, where the terms “matrix”, “matrix factor”, “matrix features” are replaced by “multi-dimensional tensor”, “multi-dimensional tensor factor”, “multi-dimensional tensor features”, respectively.

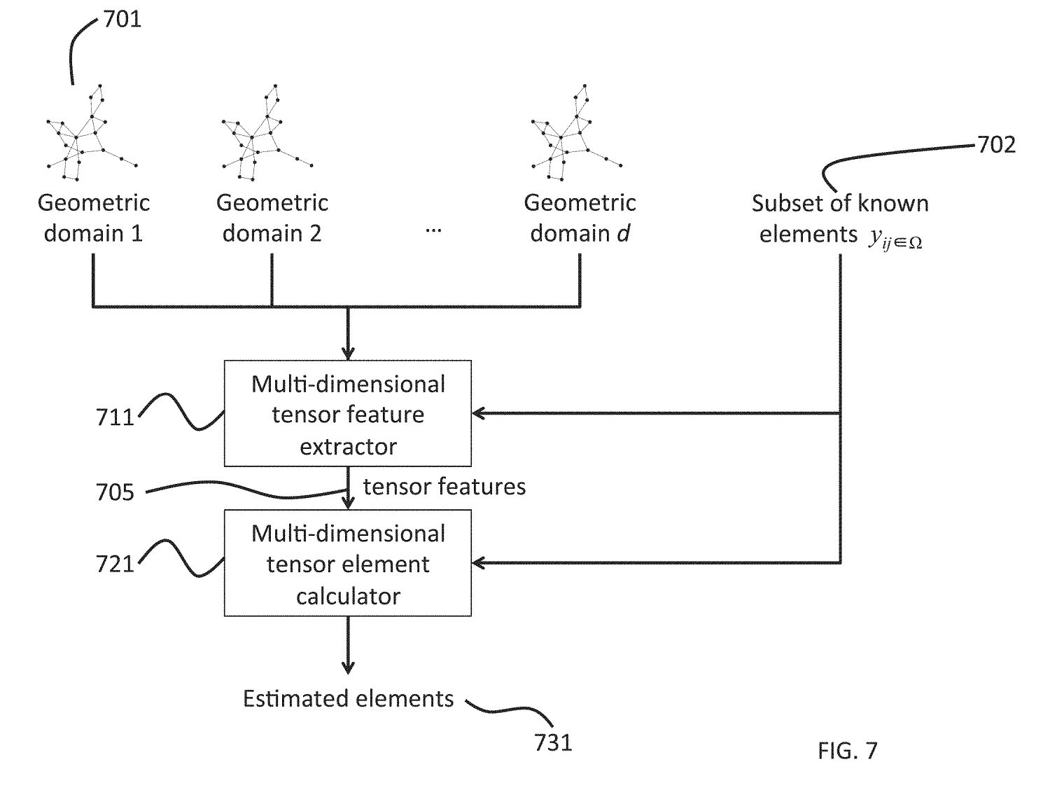

FIG. 7 depicts a high-level flow diagram of a method for estimating the elements of a d-dimensional tensor. A set of d geometric domains 701 (corresponding to the dimensions of the tensor) are provided as input along with the known elements 702 thereof. A Multi-dimensional tensor feature extractor 711 is first applied to produce multi-dimensional tensor features 705. The multi-dimensional tensor features 705 are then used by a Multi-dimensional tensor element calculator 721 to produce estimated multi-dimensional tensor elements 731.

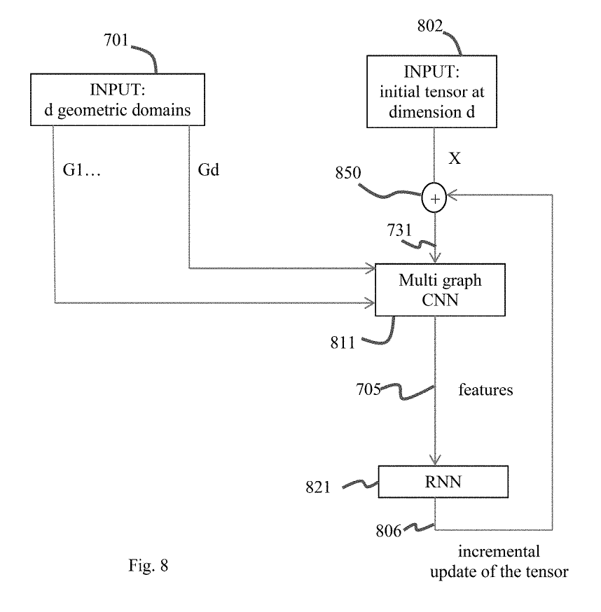

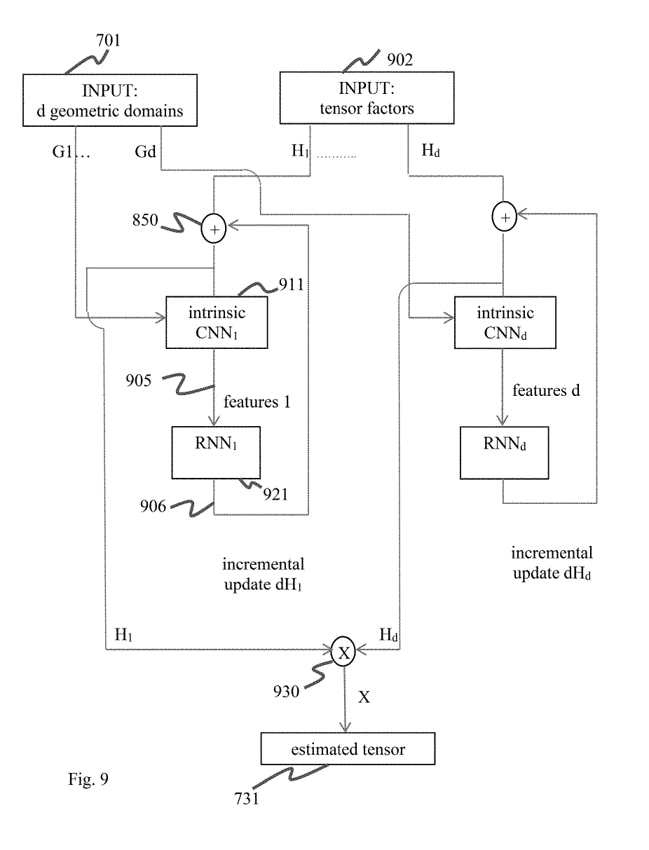

FIGS. 8 and 9 provide further specifications of the Multi-dimensional tensor feature extractor 711 Multi-dimensional tensor element calculator 721 according to some of the embodiments of the invention.

FIG. 8 depicts the flow diagram of one of the preferred embodiments of the invention applied to a multi-dimensional tensor completion problem. Initial d-dimensional tensor 802 and a set of d geometric domains 701 are provided as input to a Multi-domain CNN 811 that produces a set of tensor features 705. The tensor features 705 are fed into an RNN 821 that produces an incremental update of the tensor 806. The incremental update 806 is added to the current tensor by means of an adder 850. The process is repeated several times, producing each time an improving estimate of the tensor 731.

FIG. 9 depicts the flow diagram of one of the preferred embodiments of the invention applied to a multi-dimensional tensor completion problem. Initial d-dimensional tensor is given in the form of d factors 902, which, together with a set of d geometric domains 701 are provided as input. Each factor and the corresponding geometric domain is fed into a single-domain intrinsic CNN 911, producing the respective factor features 905. The factor features are fed into an RNN 921 that produces an incremental update of the factor 906. The incremental update 906 is added to the current factor by means of an adder 850. The process is repeated several times, producing each time an improving estimate of the factors. The product of the factors by means of a tensor multiplier 930 produces an improving estimate of the tensor 931.

In some embodiments of the invention, a combination of the embodiments depicted in FIG. 8 and FIG. 9 can be used, applying the multi-domain approach to some combinations of the dimensions of the tensor.

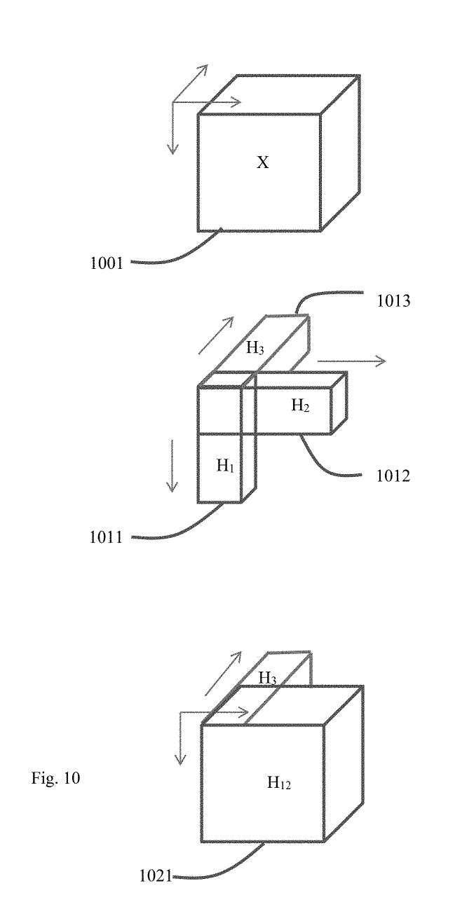

FIG. 10 exemplifies such combined embodiments on a three-dimensional tensor completion problem. This settings can be treated in at least three ways: First, by means of a three-domain CNN working on three domains simultaneously (non-factorized representation 1001 corresponding to the method depicted in FIG. 8); Second, the tensor can be factorized into three factors 1011, 1012 and 1013, for each of which a single-domain intrinsic CNN is applied (corresponding to the method depicted in FIG. 9); Third, the tensor can be factorized into two factors 1021 and 1023, one of which (1021) is treated by means of a two-domain CNN and another (1023) by a single-domain CNN (corresponding to a combination of the method depicted in FIG. 8 applied to factor 1021 and of method depicted in FIG. 9 applied to factor 1023).

In some embodiments, the methods and processes described herein can be embodied as code and/or data. The software code and data described herein can be stored on one or more (non-transitory) machine-readable media (e.g., computer-readable media), which may include any device or medium that can store code and/or data for use by a computer system. When a computer system reads and executes the code and/or data stored on a computer-readable medium, the computer system performs the methods and processes embodied as data structures and code stored within the computer-readable storage medium.

It should be appreciated by those skilled in the art that machine-readable media (e.g., computer-readable media) include removable and non-removable structures/devices that can be used for storage of information, such as computer-readable instructions, data structures, is program modules, and other data used by a computing system/environment. A computer-readable medium includes, but is not limited to, volatile memory such as random access memories (RAM, DRAM, SRAM); and non-volatile memory such as flash memory, various read-only-memories (ROM, PROM, EPROM, EEPROM), magnetic and ferromagnetic/ferroelectric memories (MRAM, FeRAM), and magnetic and optical storage devices (hard drives, magnetic tape, CDs, DVDs); network devices; or other media now known or later developed that is capable of storing computer-readable information/data. Computer-readable media should not be construed or interpreted to include any propagating signals. A computer-readable medium that can be used with embodiments of the subject invention can be, for example, a compact disc (CD), digital video disc (DVD), flash memory device, volatile memory, or a hard disk drive (HDD), such as an external HDD or the HDD of a computing device, though embodiments are not limited thereto. A computing device can be, for example, a laptop computer, desktop computer, server, cell phone, or tablet, though embodiments are not limited thereto.

In some embodiments, one or more (or all) of the steps performed in any of the methods of the subject invention can be performed by one or more processors (e.g., one or more computer processors). For example, any or all of the means to obtain at least a subset of the multi-dimensional tensor elements representing scores given to a subset of items by a subset of users and/or a provided plurality of geometric domains corresponding to a subset of the dimensions of said multi-dimensional tensor, the means to compute multi-dimensional tensor features by applying at least a multi-domain intrinsic convolutional layer on the multi-dimensional tensor elements and/or a full set of multi-dimensional tensor elements from the multi-dimensional tensor features and/or a recommendation of said plurality of items to said plurality of users using said full set of multi-dimensional tensor elements, and the means to provide in output said recommendation of said plurality of items to said plurality of users can include or be a processor (e.g., a computer processor) or other computing device.

It should be understood that the examples and embodiments described herein are for illustrative purposes only and that various modifications or changes in light thereof will be suggested to persons skilled in the art and are to be included within the spirit and purview of this application.

All patents, patent applications, provisional applications, and publications referred to or cited herein are incorporated by reference in their entirety, including all figures and tables, to the extent they are not inconsistent with the explicit teachings of this specification.

What is claimed is:

1. A computer implemented method for producing a recommendation of a plurality
of items to a plurality of users, comprising the steps of:
obtaining a subset of multi-dimensional tensor elements representing scores given to a subset of items by a subset of users;
obtaining a plurality of geometric domains corresponding to a subset of the dimensions of said multi-dimensional tensor;
computing multi-dimensional tensor features by applying at least a multi-domain intrinsic convolutional layer on the multi-dimensional tensor elements;
computing a full set of multi-dimensional tensor elements from the multi-dimensional tensor features;
using said full set of multi-dimensional tensor elements to determine recommendation of said plurality of items to said plurality of users.

2. The method of claim 1, where each of the geometric domains is one of the following types:
a manifold;
a parametric surface;
an implicit surface;
a mesh;
a point cloud;
an undirected weighted or unweighted graph;
a directed weighted or unweighted graph;
and the geometric domains are all of the same type or of different types.

3. The method of claim 1, where the multi-dimensional tensor is a two-dimensional matrix.

4. The method of claim 1, where said step of obtaining a subset of multi-dimensional tensor elements comprising inputting said subset of multi-dimensional tensor elements.

5. The method of claim 1, where said step of obtaining a plurality of geometric domains comprises inputting said plurality of geometric domains.

6. The method of claim 1, where the step of computing the multi-dimensional tensor elements from the multi-dimensional tensor features further comprises the step of applying a neural network comprising at least a linear layer on the multi-dimensional tensor features.

7. The method of claim 1, where the step of computing the multi-dimensional tensor elements from the multi-dimensional tensor features further comprises the steps of
obtaining the multi-dimensional tensor features;
computing a sequence of incremental updates of intermediate multi-dimensional tensor elements; and
using said sequence of incremental updates of intermediate multi-dimensional tensor elements for computing said multi-dimensional tensor elements.

8. The method of claim 7, where the step of computing a sequence of incremental updates of the intermediate multi-dimensional tensor elements comprises applying at least one iteration of a recurrent process to the obtained multi-dimensional tensor features.

9. The method of claim 8, where the recurrent process is implemented as one of the following:
a recurrent neural network;
a long-short term memory network.

10. The method of claim 7, where the step of computing the multi-dimensional tensor elements comprises summing up the sequence of incremental updates of the intermediate multi-dimensional tensor elements.

11. The method of claim 1, where the multi-dimensional tensor is given as a product of a plurality of factors.

12. The method of claim 11, where the multi-dimensional tensor is a two-dimensional matrix given as a product of two factors.

13. The method of claim 11, where the multi-dimensional tensor features comprise the factor features of each of the factors, and where the step of computing the multi-dimensional tensor features comprises applying at least an intrinsic convolutional layer to each of the factors to compute the factor features.

14. The method of claim 11, where the step of computing the multi-dimensional tensor elements further comprises the steps of:
computing the elements of each of the factors, and
computing the product of said factors.

15. The method of claim 11, where the multi-dimensional tensor features comprise the factor features of each of the factors, and where the step of computing the multi-dimensional tensor features comprises applying at least a multi-domain intrinsic convolutional layer to at least one of the factors to compute the factor features.

16. The method of claim 11, where each of the factors has a corresponding geometric domain.

17. The method of claim 11, where only a subset of the factors has corresponding geometric domains, and the remaining factors have no corresponding geometric domains.

18. The method of claim 17, where the step of computing the factor elements comprises the steps of:
computing factor elements of the factors having corresponding geometric domains by applying at least an intrinsic convolutional layer to each of the said factors to compute the factor features.

19. The method of claim 13, where the step of computing the multi-dimensional tensor elements further comprises the steps of:
for each of the multi-dimensional tensor factors obtaining the factor features;
computing a sequence of incremental updates of intermediate factor elements;
computing said factor elements using said sequence of incremental updates of intermediate factor elements;
computing the multi-dimensional tensor elements by using the factor elements of all the factors.

20. The method of claim 19, where the step of computing a sequence of incremental updates of intermediate factor elements comprises applying at least one iteration of a recurrent process to the factor features.

21. The method of claim 20, where the recurrent process is implemented as one of the following
a recurrent neural network;
a long-short term memory network.

22. The method of claim 19, where the step of computing the factor elements comprises summing up the sequence of incremental updates of the intermediate factor elements.

23. The method according to claim 1, further applying at least one of the following layers:
a linear layer, including outputting a weighted linear combination of input data;
a non-linear layer, including applying a non-linear function to input data;
a spatial pooling layer, including:
determining a subset of points on the geometric domain;
for each point of said subset, determining the neighbours on the geometric domain; and
computing an aggregation operation on input data over the neighbours for all the points of said subset;
a fully connected layer, including outputting a weighted linear combination of input data at all the points of the geometric domain;
a regularization layer,
wherein each layer has input data and output data and output data of one layer are given as input data to another layer.

24. The method of claim 23, wherein two or more of said layers are applied in sequence, and the output data of one layer in the sequence is given as input data to a subsequent layer in the sequence.

25. The method of claim 23, wherein the aggregation operation in a spatial pooling layer comprises one of the following:
maximum computation;
average computation;
weighted average computation;
average of squares computation.

26. The method of claim 1, where the multi-domain intrinsic convolutional layer is one of the following:
a spectral multi-domain intrinsic convolutional layer;
a spectrum-free multi-domain intrinsic convolutional layer;
a spatial multi-domain intrinsic convolutional layer.

27. The method of claim 13, wherein the intrinsic convolutional layer is one of the following:
spectral convolutional layer;
spectrum-free convolutional layer;
spatial convolutional layer.

28. The method of claim 23, where the regularization layer comprises at least one of the following:
a drop out of an arbitrary percentage of layer variables;
a quadratic penalty of the variables.

29. The method of claim 1, where for each of the dimensions of the multi-dimensional tensor, a geometric domain is provided as input.

30. The method of claim 1, where the step of obtaining the geometric domains further comprises the steps of:
inputting geometric domains corresponding to a provided subset of the dimensions of the multi-dimensional tensor;
computing the geometric domains corresponding to the non-provided subset of the dimensions of the multi-dimensional tensor from the subset of multi-dimensional tensor elements.

31. The method of claim 30, where the step of computing the geometric domain corresponding to the non-provided subset of the dimensions of the multi-dimensional tensor comprises the following steps, for each of the non-provided dimensions:
extracting multi-dimensional tensor elements along said dimension and representing them as vectors;
computing a metric between each pair of said vectors;
building a graph, whose edges are weighted according to the said metric.

32. The method of claim 30, where the step of computing the geometric domain corresponding to the non-provided subset of the dimensions of the multi-dimensional tensor comprises the following steps, for each of the non-provided dimensions:
collecting multi-dimensional features representing the general behavior of entries of said dimension and represent them as vectors;
computing a metric between each pair of said vectors;
building a graph, whose edges are weighted according to the said metric.

33. The method of claim 23, wherein more than one of said layers are applied and wherein parameters of the applied layers comprise one or more of the following:
weights and biases of the linear layers;
parameters of the multi-domain intrinsic convolutional layers, comprising one or more of the following:
spectral multipliers of multi-domain filters;
parameters of the spectrum-free multi-domain filter expansion;
parameters of the weighting functions used to compute the patch operators in the spatial multi-domain intrinsic convolutional layer;

34. The method of claim 23, wherein more than one of said layers are applied and wherein parameters of the applied layers comprise one or more of the following:
elements of the factors having no corresponding geometric domains;
weights and biases of the linear layers;
parameters of the intrinsic convolutional layers, comprising one or more of the following:
spectral multipliers of filters;
parameters of the spectrum-free filter expansion;
parameters of the weighting functions used to compute the patch operators in the spatial intrinsic convolutional layer.

35. The method of claim 33, wherein parameters of the applied layers are determined by minimizing a cost function by means of an optimization procedure.

36. The method of claim 35, where the optimization procedure comprises minimizing one or more of the following:
the discrepancy between the input known multi-dimensional tensor elements and the corresponding subset of the computed multi-dimensional tensor elements;
a criterion of smoothness of multi-dimensional tensor elements;
a surrogate of the rank of the multi-dimensional tensor;
norms of the multi-dimensional tensor factors.

37. The method of claim 36, where the criterion of smoothness is the Dirichlet norm on the respective on the respective geometric domains.

38. The method of claim 33, wherein parameters of the applied layers further comprise parameters of the geometric domains.

39. The method of claim 38, wherein the parameters of the geometric domains comprise the metrics of said geometric domains.

40. The method of claim 38, wherein the at least one of the geometric domains is a graph and the parameters of said geometric domain are the edge weights of the graph.

41. The method of claim 40, wherein the vertices of the graph are points in a feature space, and edge weights are computed by applying a parametric metric between pairs of points in said feature space, and the parameters of the geometric domain comprise the parameters of said parametric metric.

42. The method of claim 41, wherein parameters of the applied layers and parameters of the geometric domains are determined by minimizing a cost function by means of an optimization procedure.

43. The method of claim 1, where the step of using the full set of multi-dimensional tensor elements to output recommendation of a plurality of items to a plurality of users further comprising producing for each user a list of recommended items.

44. The method of claim 43, the step of producing for each user a list of recommended items comprises at least one of the following:
sorting the subset of the multi-dimensional tensor elements corresponding to a user from the highest score to the lowest score;
extracting a subset of the highest scores;
outputting the items corresponding to the extracted highest scores.

45. A computer system for producing a recommendation of a plurality of items to a plurality of users, the computer system including:
means to obtain:
at least a subset of the multi-dimensional tensor elements representing scores given to a subset of items by a subset of users;
a provided plurality of geometric domains corresponding to a subset of the dimensions of said multi-dimensional tensor;
means to compute:
multi-dimensional tensor features by applying at least a multi-domain intrinsic convolutional layer on the multi-dimensional tensor elements;
a full set of multi-dimensional tensor elements from the multi-dimensional tensor features;
a recommendation of said plurality of items to said plurality of users using said full set of multi-dimensional tensor elements; and
means to provide in output said recommendation of said plurality of items to said plurality of users.

46. The system of claim 45, where each of the geometric domains is one of the following types:
a manifold;
a parametric surface;
an implicit surface;
a mesh;
a point cloud;
an undirected weighted or unweighted graph;
a directed weighted or unweighted graph;
and the geometric domains are all of the same type or of different types.

47. The system of claim 45, where the multi-dimensional tensor is a two-dimensional matrix.

48. The system of claim 45, where said means to obtain the geometric domains comprises means to take in input the geometric domains.

49. The system of claim 45, where said means to obtain at least a subset of the multi-dimensional tensor elements comprises means to take in input only a subset of the multi-dimensional tensor elements, said means to obtain the geometric domains are configured to compute the geometric domains from said subset of the multi-dimensional tensor elements.

50. The system of claim 45, where said means to compute the multi-dimensional tensor elements from the multi-dimensional tensor features are configured to apply a neural network comprising at least a linear layer on the multi-dimensional tensor features.

51. The system of claim 45, where said means to compute the multi-dimensional tensor elements from the multi-dimensional tensor features are further configured to:
input the multi-dimensional tensor features;
compute a sequence of incremental updates of intermediate multi-dimensional tensor elements; and
use said sequence of incremental updates of intermediate multi-dimensional tensor elements for computing said multi-dimensional tensor elements.

52. The system of claim 51, where said means to compute are further configured to apply at least one iteration of a recurrent process to the input multi-dimensional tensor features for computing said sequence of incremental updates of the multi-dimensional tensor.

53. The system of claim 52, where said means to compute are configured to implement said recurrent process as:
a recurrent neural network;
a long-short term memory network.

54. The system of claim 51, where said means to compute the multi-dimensional tensor elements are configured to sum the sequence of incremental updates of the multi-dimensional tensor elements.

55. The system of claim 45, where the said means to obtain the multi-dimensional tensor are configured to receive the multi-dimensional tensor as a product of a plurality of factors.

56. The system of claim 55, where the multi-dimensional tensor is a two-dimensional matrix given as a product of two factors.

57. The system of claim 55, where the multi-dimensional tensor features comprise the factor features of each of the factors, and where the means to compute the multi-dimensional tensor features are configured to apply at least an intrinsic convolutional layer to each of the factors to compute the factor features.

58. The system of claim 55, where the means to compute the multi-dimensional tensor elements are further configured to compute:
the elements of each of the factors, and
the product of said factors.

59. The system of claim 55, where tensor features comprise the factor features of each of the factors, and where the means to compute the multi-dimensional tensor features are configured to apply at least a multi-domain intrinsic convolutional layer to at least one of the factors to compute the factor features.

60. The system of claim 55, where each of the factors has a corresponding geometric domain.

61. The system of claim 55, where only a subset of the factors has corresponding geometric domains, and the remaining factors have no corresponding geometric domains.

62. The system of claim 61, where said means to compute the factor elements are configured to compute factor elements of the factors having corresponding geometric domains by applying at least an intrinsic convolutional layer to each of the said factors to compute the factor features.

63. The system of claim 57, where said means to compute the multi-dimensional tensor elements are further configured to:
for each of the multi-dimensional tensor factors
inputting the factor features;
computing a sequence of incremental updates of intermediate factor elements;
computing said factor elements using said sequence of incremental updates of intermediate factor elements;
computing the multi-dimensional tensor elements by using the factor elements of all the factors.

64. The system of claim 63, where the said means to compute the sequence of incremental updates of intermediate factor elements are configured to apply at least one iteration of a recurrent process to the factor features.

65. The system of claim 64, where said means to compute the sequence of incremental updates of intermediate factor elements are configured to implement the recurrent process as one of the following:
a recurrent neural network;
a long-short term memory network.

66. The system of claim 63, where said means to compute the factor elements are configured to sum the sequence of incremental updates of the intermediate factor elements.

67. The system according to claim 45, wherein said means to compute said multi-dimensional tensor features are further configured to apply at least one of the following layers:
a linear layer, including outputting a weighted linear combination of input data;
a non-linear layer, including applying a non-linear function to input data;
a spatial pooling layer, by:
determining a subset of points on the geometric domain;
for each point of said subset, determining the neighbours on the geometric domain; and
computing an aggregation operation on input data over the neighbours for all the points of said subset;
a fully connected layer, including outputting a weighted linear combination of input data at all the points of the geometric domain;
a regularization layer,
wherein each layer has input data and output data and said means to computer are configured to give output data of one layer as input data to another layer.

68. The system of claim 67, wherein said means to compute said multi-dimensional tensor features are configured to apply two or more of said layers in sequence, and to give the output data of one layer in the sequence as input data to a subsequent layer in the sequence.

69. The system of claim 67, wherein the aggregation operation in a spatial pooling layer comprises one of the following:
maximum computation;
average computation;
weighted average computation;
average of squares computation.

70. The system of claim 45, where the multi-domain intrinsic convolutional layer is one of the following:
a spectral multi-domain intrinsic convolutional layer;
a spectrum-free multi-domain intrinsic convolutional layer;
a spatial multi-domain intrinsic convolutional layer.

71. The system of claim 57, wherein the intrinsic convolutional layer is one of the following:
spectral convolutional layer
spectrum-free convolutional layer
spatial convolutional layer.

72. The system of claim 67, where the regularization layer comprises at least one of the following:
a drop out of an arbitrary percentage of layer variables;
a quadratic penalty of the variables

73. The system of claim 45, where said means to obtain a plurality of geometric domains are configured to take in input a geometric domains for each of the dimensions of the multi-dimensional tensor.

74. The system of claim 45, where said means to obtain a plurality of geometric domains are further configured to:
inputting geometric domains corresponding to a provided subset of the dimensions of the multi-dimensional tensor;
computing the geometric domains corresponding to the non-provided subset of the dimensions of the multi-dimensional tensor from the subset of multi-dimensional tensor elements.

75. The system of claim 74, where said means to obtain a plurality of geometric domains are further configured, for each of the non-provided dimensions, to:
extracting multi-dimensional tensor elements along said dimension and representing them as vectors;
computing a metric between each pair of said vectors;
building a graph, whose edges are weighted according to the said metric.

76. The system of claim 74, where said means to obtain a plurality of geometric domains are further configured, for each of the non-provided dimensions to:
collect multi-dimensional features representing the general behavior of entries of said dimension and represent them as vectors;
computing a metric between each pair of said vectors;
building a graph, whose edges are weighted according to the said metric.

77. The system of claim 67, wherein said means to compute said multi-dimensional tensor features are configured to apply more than one of said layers and wherein parameters of the applied layers comprise one or more of the following:
weights and biases of the linear layers;
parameters of the multi-domain intrinsic convolutional layers, comprising one or more of the following:
spectral multipliers of multi-domain filters;
parameters of the spectrum-free multi-domain filter expansion;
parameters of the weighting functions used to compute the patch operators in the spatial multi-domain intrinsic convolutional layer;

78. The system of claim 67, wherein said means to compute said multi-dimensional tensor features are configured to apply more than one of said layers and wherein parameters of the applied layers comprise one or more of the following:
elements of the factors having no corresponding geometric domains;
weights and biases of the linear layers;
parameters of the intrinsic convolutional layers, comprising one or more of the following:
spectral multipliers of filters;
parameters of the spectrum-free filter expansion;
parameters of the weighting functions used to compute the patch operators in the spatial intrinsic convolutional layer.

79. The system of claim 77, wherein said means to compute said multi-dimensional tensor features are configured determine the parameters of the applied layers by minimizing a cost function by means of an optimization procedure.

80. The system of claim 79, where the optimization procedure is implemented to minimize one or more of the following:
the discrepancy between the input known multi-dimensional tensor elements and the corresponding subset of the computed multi-dimensional tensor elements;
a criterion of smoothness of multi-dimensional tensor elements;
a surrogate of the rank of the multi-dimensional tensor;
norms of the multi-dimensional tensor factors.

81. The system of claim 80, where the criterion of smoothness is the Dirichlet norm on the respective on the respective geometric domains.

82. The system of claim 77, wherein the parameters of the applied layers further comprise parameters of the geometric domains.

83. The system of claim 82, wherein the parameters of the geometric domains comprise the metrics of said geometric domains.

84. The system of claim 82, wherein the at least one of the geometric domains is a graph and the parameters of said geometric domain are the edge weights of the graph.

85. The system of claim 84, wherein the vertices of the graph are points in a feature space, and said means to compute said multi-dimensional tensor features are configured to compute the edge weights by applying a parametric metric between pairs of points in said feature space, and the parameters of the geometric domain comprise the parameters of said parametric metric.

86. The system of claim 85, wherein said means to compute said multi-dimensional tensor features are configured to determine parameters of the applied layers and parameters of the geometric domains by minimizing a cost function by means of an optimization procedure.

87. The system of claim 45, where said means to compute the full set of multi-dimensional tensor elements is further configured to produce for each user a list of recommended items.

88. The system of claim 87, where the list of recommended items comprises at least one of the following:
sorting the subset of the multi-dimensional tensor elements corresponding to a user from the highest score to the lowest score;
extracting a subset of the highest scores;
outputting the items corresponding to the extracted highest scores.
